(19) United States
(12) Patent Application Publication
(10) Pub. No.: US 2004/0172273 A1
(43) Pub. Date: Sep. 2, 2004

(54) Selling paper through organizations

(76) Inventor: Michael R. Nowak, Hilbert, WI (US)

Correspondence Address: Philip M. Weiss, Weiss & Weiss, 310 Old Country Road, Garden City, NY, 11530, US

(21) Appl. No.: 10/750,071

(22) Filed: Dec. 31, 2003

Related U.S. Application Data
(60) Provisional application No. 60/437,469, filed on Dec. 31, 2002.

(51) Int. Cl. G06F 17/60

(52) U.S. Cl. 705/1

(57) ABSTRACT

A new method of selling copier and printer paper through community organizations.

### RELATED APPLICATIONS

The present application claims priority from U.S. Provisional Application Serial No. 60/437,469 filed Dec. 31, 2002.

### FIELD OF THE INVENTION

The present invention relates to a method of selling reams of copier or printer paper through groups or organizations as fund raising projects.

### BACKGROUND OF THE INVENTION

As more people have acquired home computers and printers the use of copier and printer paper by consumers has increased. Consumers traditionally purchase copier and printer paper at an office supply store, retail store, or through an office supply catalog.

Community organizations (school groups, church groups, Boy Scouts, etc) have traditionally sold a variety of products to raise money to support their activities and causes. These have been in the form of foods (cookies, fruit, candies, pizza, etc), items from catalogs, magazines, candles, wrapping paper, to name a few.

Many of these items are of limited use to the consumer, but they purchase something to support the organization. Many of the foods being sold are coming under fire for having limited nutritional value and contributing to dietary problems. Further many of the items have a holiday theme and therefore are limited to certain times of the year.

### SUMMARY OF THE INVENTION

The present invention relates to a method of selling copier and printer paper. It is an object of the present invention to sell the paper in different quantities. It is an object of the invention to provide a home owner the option to buy paper according to his or her demand for paper. It is an object of the present invention for the paper to be packaged in reams of 50 to 1,000 sheets. It is an object of the present invention for an individual or organization to sell paper to a home owner who can then purchase the paper based on demands of the home owner. It is an object of the present invention for the paper to be sold through a number of methods including door to door, at stands, over the Internet, etc. It is an object for the ream wrapper of the paper to have a design, logo or other identification means placed on it. It is an object of the present invention for the paper to have a design logo or other identification means placed on it.

It is a further object of the invention for the paper to have placed on it information which is requested by the buyer before purchase. Since most organizations sell their fund raising items during holiday seasons, it is an object of the invention for the paper to have a holiday motif included with it.

It is an object of the present invention for the paper to be scented. It is an object of the present invention for the paper to be of different colors. It is an object of the present invention for the paper to have a border and allow the buyer to choose different backgrounds for the borders. It is an object of the present invention for the backgrounds to be chosen from clip art. It is an object of the present invention for the paper to be of different sizes.

It is an object of the present invention for the paper to be made in different shapes. It is an object of the present invention for the paper to be three hole punched. It is an object of the present invention for the paper to be photo paper. It is an object of the present invention for the paper to be computer paper. It is an object of the present invention for the paper to be loose leaf paper.

It is an object of the present invention to for the organization to sell other types of supplies to the homeowner, such as pens, pencils, and ink jet cartridges.

It is an object of the present invention for the organization to be able to raise money at all times of the year based on the sales of the paper products.

### BRIEF DESCRIPTION OF THE DRAWINGS

FIG. 1 illustrates a method of selling paper through organizations.

### DETAILED DESCRIPTION OF THE INVENTION

In an embodiment of the present invention the paper is packaged in reams of 50 to 1,000 sheets and sold by community organizations to raise money. The organization may or may not have a logo, design or name on the ream wrapper on the package of paper to promote the organization and its activities. The organizations can sell the paper through a variety of methods including door to door, at stands, over the Internet, etc.

The following is an example of the present invention. A person selling on behalf of an organization approaches a person via a telephone, in person, or on the Internet. On behalf of the organization they provide information to an individual regarding the type of paper that they are selling, the quantity and the cost. In a preferred embodiment, the person selling provides a form to the user regarding this information. The individual can then check off or put in writing the order for paper which they are requesting. Payment is provided by the individual. The person selling when they are finished takes this information to their organization. The organization then receives the paper in the proper quantities and provides through the persons selling the paper the finished product to be delivered to the individual. Individuals receive a product which is useful to them and will be used in the future.

In an embodiment, the organization can sell paper, which has different scents. Paper can be made available to the buyers which is of different colors. In an embodiment of the present invention a buyer can order paper which has a border which can have several types of borders. The buyer can choose the different backgrounds from clip art. In a further embodiment, the buyer can choose different sizes and shapes of paper. The buyer can also choose paper that is three hole punched. The paper can also be computer paper, loose leaf paper or photo paper.

The present invention allows an organization to be able to raise money at all times of the year based on the sales of the paper products.

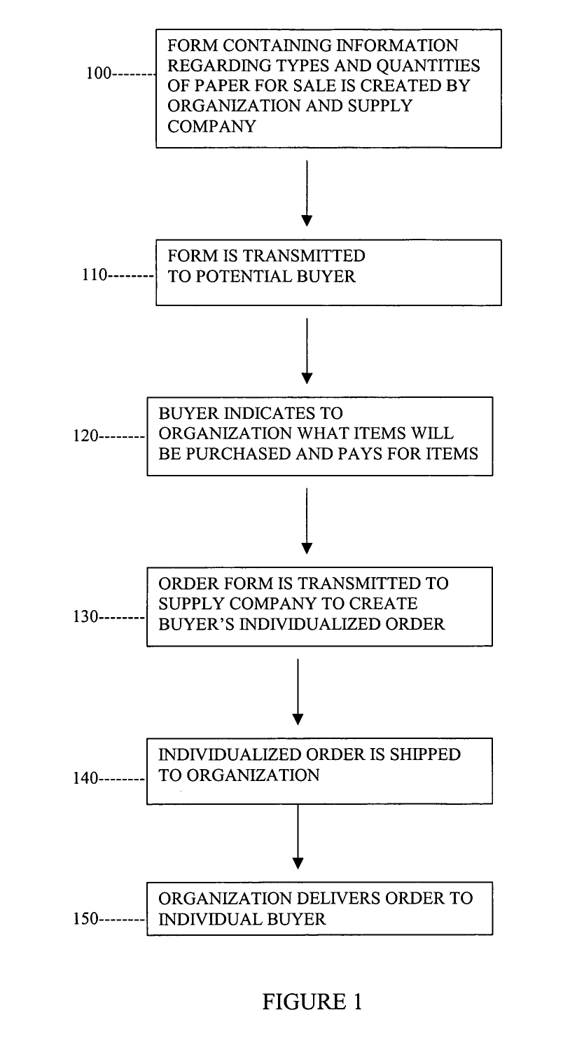

FIG. 1 illustrates a method of selling paper through organizations.

A form containing information regarding types and quantities of paper for sale is created by the organization and the supply company. The form is transmitted by the organization to the potential buyer. The form can be transmitted by facsimile, Internet or in person via door to door. The buyer then indicates to the organization what items will be purchased and pays for them. The order form is then transmitted from the organization to the supply company, which then creates the individualized order. The individualized order is then shipped to the organization by the supplier. The organization then delivers the order to the individual buyer.

1. A method for fund raising comprising:
approaching an individual on behalf of an organization;
providing information to said individual regarding type, quantity and cost of paper;
ordering said paper;
paying for said paper;
providing said information to said organization;
receiving said paper from a paper company; and
providing said paper to said individual.

2. The method of claim 1 wherein said paper is wrapped in a ream wrapper which has an identification of said organization on said wrapper.

3. The method of claim 1 wherein said paper is sold in quantities which are chosen by the buyer.

4. The method of claim 3 wherein said paper is packaged in reams of 50 to 1,000 sheets.

5. The method of claim 1 wherein said paper is sold by door to door, at stands, by telephone, facsimile, or over the Internet.

6. The method of claim 1 wherein said paper has a design, logo or other identification means placed on it.

7. The method of claim 1 wherein said paper has information placed on it which is requested by said individual before purchase.

8. The method of claim 1 wherein said paper has a holiday motif printed on it.

9. The method of claim 1 wherein said buyer can choose different borders for said paper. It is an object of the present invention for the paper to be of different sizes.

10. The method of claim 1 wherein said paper can be of different size, shape and color.

11. The method of claim 1 wherein said paper is selected from the group consisting of copier paper, computer paper, photo paper, and loose leaf paper.

12. The method of claim 1 wherein said buyer can also order other supplies, such as pens, pencils, and ink jet cartridges.

13. The method of claim 1 wherein said organization can raise money at all times of the year based on sales of said paper products.
